(19) United States
(12) Patent Application Publication
(10) Pub. No.: US 2026/0058062 A1
(43) Pub. Date: Feb. 26, 2026

(54) MULTILAYER CERAMIC ELECTRONIC COMPONENT

(71) Applicant: Murata Manufacturing Co., Ltd., Nagaokakyo-shi (JP)

(72) Inventor: Shinobu CHIKUMA, Nagaokakyo-shi (JP)

(21) Appl. No.: 19/367,918

(22) Filed: Oct. 24, 2025

Related U.S. Application Data
(63) Continuation of application No. PCT/JP2024/019023, filed on May 23, 2024.

(30) Foreign Application Priority Data
Jun. 8, 2023 (JP) 2023-094856

(51) Int. Cl. H01G 4/232; H01G 2/06; H01G 4/008; H01G 4/012; H01G 4/12; H01G 4/30

(52) U.S. Cl. CPC H01G 4/232; H01G 2/065; H01G 4/008; H01G 4/012; H01G 4/12; H01G 4/30

(57) ABSTRACT

A multilayer ceramic electronic component includes a multilayer body including an inner layer portion including dielectric layers and internal electrode layers alternately stacked, two main surfaces opposite to each other in a stacking direction and two end surfaces opposite to each other in a length direction, two external electrodes connected to the internal electrode layers at the two end surfaces, respectively, and covering the end surfaces and portions of the two main surfaces and continuous with the end surfaces, and two spacers on one of the two main surfaces of the multilayer body. The spacers each include a first region covering a portion of the multilayer body, and a second region covering a portion of an external electrode. The first and second regions include different materials.

### CROSS REFERENCE TO RELATED APPLICATIONS

This application claims the benefit of priority to Japanese Patent Application No. 2023-094856 filed on Jun. 8, 2023 and is a Continuation Application of PCT Application No. PCT/JP2024/019023 filed on May 23, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic electronic components such as multilayer ceramic capacitors are widely used in various electronic devices such as mobile terminal devices such as mobile phones, as well as personal computers. The multilayer ceramic capacitors each include a rectangular parallelepiped multilayer body in which dielectric layers and internal electrode layers are alternately laminated, and external electrodes provided on opposite ends of the multilayer body.

The multilayer ceramic capacitors each include an inner layer portion in which dielectric layers and internal electrodes are alternately stacked. In addition, a dielectric layer as an outer layer portion is provided on each of an upper portion and a lower portion of the inner layer portion to form a rectangular parallelepiped multilayer body, and external electrodes are provided on both end surfaces in a longitudinal direction of the multilayer body to form a capacitor main body.

Further, in order to suppress the occurrence of “acoustic noise”, multilayer ceramic capacitors are known that each include spacers that each cover a portion of an external electrode on a side of a capacitor main body mounted on a substrate.

However, when the bonding strength between the capacitor main body and the spacers is weak, the spacers may undergo delamination, and the durability at the time of mounting is not sufficient.

### SUMMARY OF THE INVENTION

Example embodiments of the present invention provide multilayer ceramic capacitors each with a high bonding strength between a capacitor main body and a spacer, and excellent durability when mounted.

The inventor of example embodiments of the present invention has discovered that spacers each including a first region covering a portion of a multilayer body and a second region covering a portion of an external electrode, the first region and the second region being made of different materials, have a high bonding strength to a capacitor main body and excellent durability when mounted.

More specifically, an example embodiment of the present invention provides a multilayer ceramic electronic component that includes two main surfaces on opposite sides in a lamination direction, two end surfaces on opposite sides in a length direction intersecting the lamination direction, and two lateral surfaces on opposite sides in a width direction intersecting the lamination direction and the length direction, two external electrodes each covering the corresponding one of the two end surfaces and a portion of each of the two main surfaces on opposite sides which is continuous from the corresponding one of the two end surfaces, and two spacers on one of the two main surfaces of the multilayer body. Each of the two spacers includes a first region covering a portion of the multilayer body and a second region covering a portion of a corresponding one of the two external electrodes, and the first region and the second region include different materials.

According to example embodiments of the present invention, since the bonding strength between a capacitor main body and spacers is increased, multilayer ceramic capacitors each with excellent durability when mounted are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a view showing an appearance of a multilayer ceramic capacitor 1 according to an example embodiment of the present invention.

FIG. 2 is a cross-sectional view of the multilayer ceramic capacitor 1 taken along the line II-II shown in FIG. 1.

FIG. 3 is a cross-sectional view of the multilayer ceramic capacitor 1 taken along the line III-III shown in FIG. 1.

FIGS. 4A, 4B, and 4C are plan views of various shapes of spacers 4 as viewed from a lamination direction.

FIGS. 5A and 5B are plan views of various shapes of the spacers 4 as viewed from a lamination direction.

FIG. 6 is an enlarged cross-sectional view of a portion of a second region 42 when phenol resin is used.

FIG. 7 is an enlarged cross-sectional view of a portion of a second region 42 in a case where an epoxy resin is used.

FIG. 8 is a flowchart showing a method of manufacturing the multilayer ceramic capacitor 1 according to an example embodiment of the present invention.

FIGS. 9A to 9D are diagrams showing a multilayer body manufacturing step S1, a base electrode layer forming step S2, and a plated layer forming step S3.

FIGS. 10A to 10C are diagrams showing a second region forming step in a spacer placement step S4.

### DETAILED DESCRIPTION OF THE EXAMPLE EMBODIMENTS

Example embodiments of the present invention will be described in detail below with reference to the drawings.

Hereinafter, a multilayer ceramic capacitor 1 will be described as an example embodiment of a multilayer ceramic electronic component according to the present invention, but the present invention is not limited thereto. In addition, the drawings may be schematically drawn by simplifying in order to explain the contents of example embodiments of the present invention, and the drawn components or the ratio of the dimensions between the components may not coincide with the ratio of the dimensions described in the specification. In addition, components described in the specification may be omitted in the drawings or may be drawn with the number of components reduced or omitted.

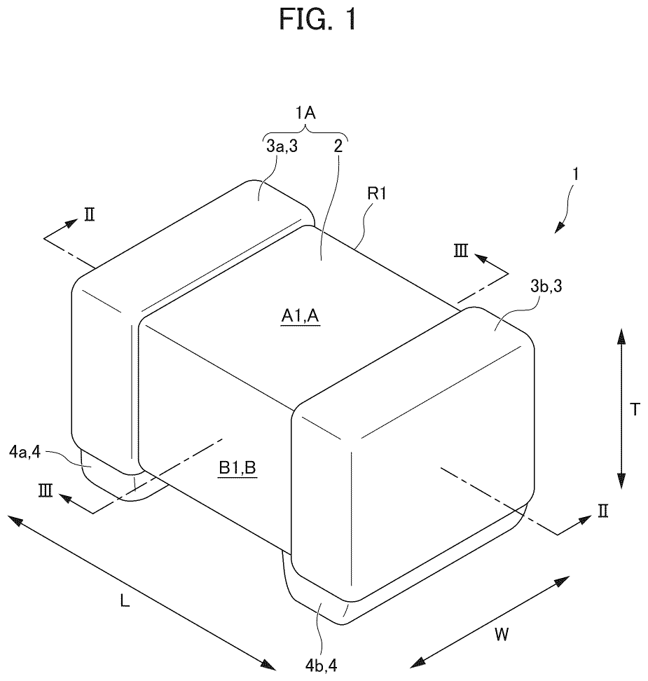

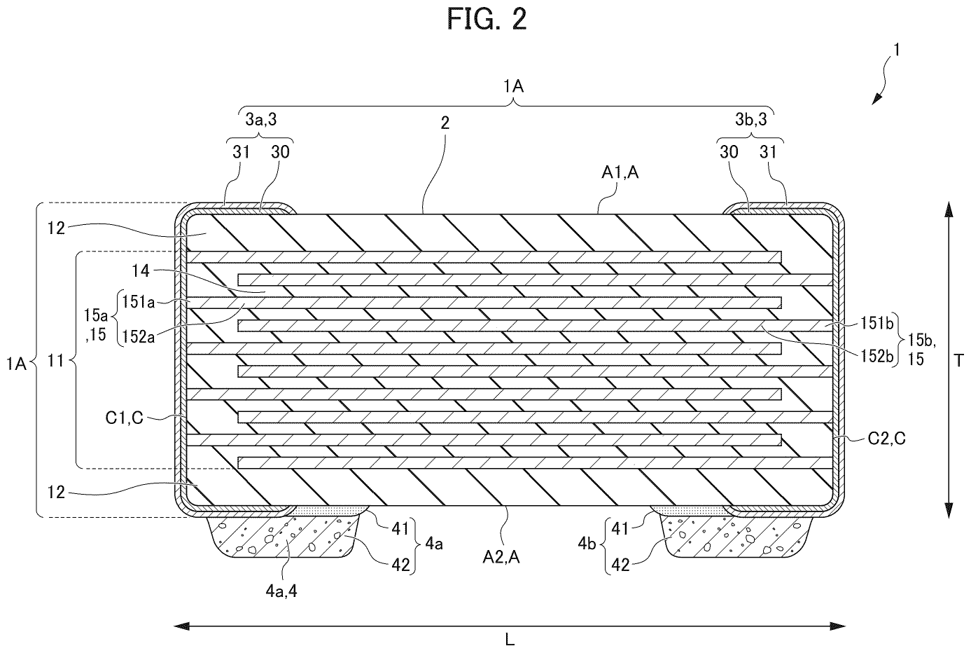

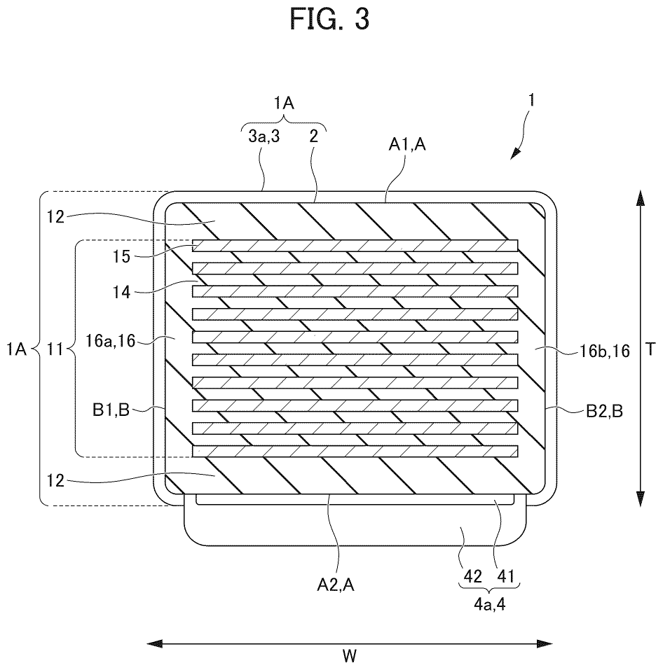

FIG. 1 is a schematic perspective view of a multilayer ceramic capacitor 1 according to an example embodiment of the present invention. FIG. 2 is a cross-sectional view of the multilayer ceramic capacitor 1 according to the present example embodiment taken along the line II-II in FIG. 1. FIG. 3 is a cross-sectional view of the multilayer ceramic capacitor 1 according to the present example embodiment taken along the line III-III in FIG. 1. In addition, FIG. 2 is a cross section parallel or substantially parallel to the length direction L and the lamination direction T, and is also referred to as an LT cross-section. Also, FIG. 3 is a cross section parallel or substantially parallel to the width direction W and the lamination direction T, and is also referred to as a WT cross-section.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, and spacers 4 attached to the capacitor main body 1A. In addition, the multilayer body 2 includes an inner layer portion 11 in which dielectric layers 14 and internal electrode layers 15 are laminated.

In the following description, as the terms representing the orientations of the multilayer ceramic capacitor 1, a direction in which the pair of external electrodes 3 are provided in the multilayer ceramic capacitor 1 is defined as a length direction L. A direction in which the dielectric layers 14 and the internal electrode layers 15 are laminated is defined as a lamination direction T. A direction intersecting both the length direction L and the lamination direction T is defined as a width direction W. In the present example embodiment, the width direction W is orthogonal to both the length direction L and the lamination direction T.

### Outer Surface of Multilayer Body 2

In addition, among the six outer surfaces of the multilayer body 2, a pair of outer surfaces on opposite sides in the lamination direction T are defined as a first main surface A1 and a second main surface A2, a pair of outer surfaces on opposite sides in the width direction W are defined as a first lateral surface B1 and a second lateral surface B2, and a pair of outer surfaces on opposite sides in the length direction L are defined as a first end surface C1 and a second end surface C2. In addition, when there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

In the multilayer body 2, it is preferable that ridge portions R1 including corner portions are rounded. Each of the ridge portions R1 is a portion where two surfaces of the multilayer body 2, that is, the main surface A and the lateral surface B, the main surface A and the end surface C, or the lateral surface B and the end surface C intersect with each other.

### Multilayer Body 2

The multilayer body 2 includes an inner layer portion 11 that generates capacitance, outer layer portions 12 that sandwich the inner layer portion 11 from the lamination direction T, and side margin portions 16 that sandwich the inner layer portion 11 and the outer layer portions 12 from the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 each include a ceramic material. As the ceramic material, for example, a dielectric ceramic including BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. Each of the first internal electrode layers 15a includes a first counter portion 152a opposed to the second internal electrode layer 15b, and a first extension portion 151a that extends from the first counter portion 152a toward the first end surface C1. An end portion of the first extension portion 151a is exposed at the first end surface C1 and is electrically connected to a first external electrode 3a described later. Each of the second internal electrode layers 15b includes a second counter portion 152b opposed to the first internal electrode layer 15a, and a second extension portion 151b that extends from the second counter portion 152b toward the second end surface C2. An end portion of the second extension portion 151b is electrically connected to a second external electrode 3b described later. Electric charges are accumulated in the first counter portion 152a of the first internal electrode layer 15a and the second counter portion 152b of the second internal electrode layer 15b.

Each of the internal electrode layers 15 preferably includes a metal material such as, for example, nickel (Ni), copper (Cu), silver (Ag), palladium (Pd), a silver-palladium (Ag—Pd) alloy, gold (Au), or other materials.

### Outer Layer Portion 12

The outer layer portions 12 may be made of the same material as the dielectric layers 14 of the inner layer portion 11.

### Side Margin Portion 16

The multilayer ceramic capacitor includes a first side margin portion 16a and a second side margin portion 16b that sandwich the inner layer portion 11 and the outer layer portions 12 from the width direction W. The first side margin portion 16a defines the first lateral surface B1 of the multilayer ceramic capacitor 1. The second side margin portion 16b defines the second lateral surface B2 of the multilayer ceramic capacitor 1. The side margin portions 16 may be made of the same material as the dielectric layers 14.

### External Electrode 3

The external electrodes 3 include a first external electrode 3a provided on the first end surface C1 and a second external electrode 3b provided on the second end surface C2. Each of the external electrodes 3 covers not only the end surface C, but also a portion of the main surface A and a portion of the lateral surface B which are continuous with the end surface C.

As described above, an end portion of the first extension portion 151a of each of the first internal electrode layers 15a is exposed at the first end surface C1 and electrically connected to the first external electrode 3a. In addition, an end portion of the second extension portion 151b of each of the second internal electrode layers 15b is exposed at the second end surface C2 and electrically connected to the second external electrode 3b. With such a configuration, a plurality of capacitor elements are electrically connected in parallel between the first external electrode 3a and the second external electrode 3b.

In addition, the external electrodes 3 each include, for example, a base electrode layer 30 and a plated layer 31. In addition, it is not necessary for the external electrodes 3 to have such a layered configuration. In addition, for example, the external electrodes 3 may include a resin electrode layer in order to alleviate stress applied to the multilayer ceramic capacitor 1.

The base electrode layer 30 is formed by, for example, applying and firing an electrically conductive paste including copper (Cu). In addition, for example, the base electrode layer 30 may include glass or a ceramic material.

The plated layer 31 includes, for example, a nickel (Ni) plated layer provided on the surface of the base electrode layer 30 and a first tin (Sn) plated layer provided on the surface of the nickel (Ni) plated layer 31a. In addition, the configuration of the plated layer 31 is not limited thereto.

### Spacer 4

The spacer 4 includes a pair of a first spacer 4a and a second spacer 4b. The first spacer 4a and the second spacer 4b are provided on the second main surface A2, which is the substrate mounting surface of the capacitor main body 1A. Further, the first spacer 4 is provided adjacent to the first end surface C1 in the length direction L. The second spacer 4b is provided adjacent to the second end surface C2 in the length direction L. In a case where the substrate mounting surface of the capacitor main body 1A is the first lateral surface B1, the first spacer 4a and the second spacer 4b are provided on the first lateral surface B1, which is the substrate mounting surface of the capacitor main body 1A. Further, the first spacer 4a is provided adjacent to the first end surface C1 in the length direction L. The second spacer 4b is provided adjacent to the second end surface C2 in the length direction L.

The spacers 4 are each provided on the surface of the external electrode 3 of the capacitor main body 1A and on the surface of the second main surface A2 of the multilayer body 2 which is continuous from the surface of the external electrode 3 of the capacitor main body 1A and on which the external electrode 3 is not provided. In a case where the substrate mounting surface of the capacitor main body 1A is the first lateral surface B1, the spacers 4 are each provided on the surface of the external electrode 3 of the capacitor main body 1A and on the surface of the first lateral surface B1 of the multilayer body 2 which is continuous from the surface of the external electrode 3 of the capacitor main body 1A and on which the external electrode 3 is not provided.

In an example embodiment of the present invention, the external electrodes 3 each include the base electrode layer 30 and the plated layer 31 covering the base electrode layer 30, and the spacers 4 are each provided on the surface of the plated layer 31. However, the plated layer 31 is not necessary, and for example, each of the spacers 4 may be provided on the surface of the base electrode layer 30.

Each of the spacers 4 includes a first region 41 covering a portion of the multilayer body 2 and a second region 42 covering a portion of the external electrode 3, and the first region 41 and the second region 42 are made of different materials.

The first region 41 is made of a material having a high bonding strength to the multilayer body 2. For example, when the first region 41 is made of a metal film by sputtering, a mixture of an electrically conductive component and a ceramic material, or a synthetic resin, since the first region 41 easily adheres to the surface of the multilayer body 2, it is possible to improve the bonding strength between the capacitor main body 1A and the spacers 4.

The first region may be made of an insulating resin. The insulating resin may include, for example, an epoxy resin as a main component and a phenol resin as a curing agent. As the other curing agent, for example, an acid anhydride curing agent, an amine curing agent, an ester curing agent, or the like may be used. A curing accelerator, for example, may be further added to the epoxy resin. The insulating resin may include, for example, only the water-repellent treatment agent.

Although the second region 42 may include various components such as a metal component and a resin component, for example, when a large amount of the metal component is included, the ratio of the volume to the surface area of the metal component increases, and thus the ESR of the multilayer ceramic electronic component decreases. On the other hand, when a large amount of the resin component is included, it is possible to relax the stress by the elasticity of the resin component. In a case where the first region 41 includes a large amount of the resin component, the second region 42 preferably includes a large amount of the metal component. It is possible to improve the mechanical strength and the deflection strength by the first region 41, and it is possible to reduce or prevent the increase in ESR by the second region 42.

As the resin component of the second region 42, for example, a resin such as a phenol resin or an epoxy resin may be used.

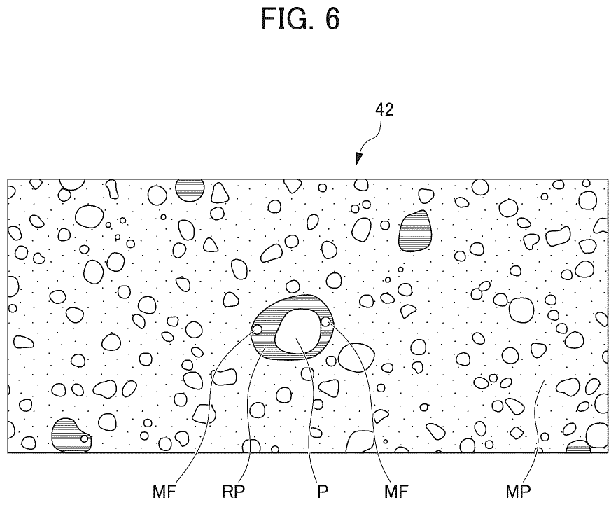

FIG. 6 shows an example of the configuration of the second region 42 when the second region is made using a phenol resin. FIG. 6 is a partially enlarged view of a cross section of an internal region of the second region 42.

The second region 42 shown in FIG. 6 includes, for example, either copper (Cu) or nickel (Ni) and tin (Sn) as metal powder. The copper (Cu) and nickel (Ni) may be coated with, for example, silver (Ag). The intermetallic compound formed by adding either copper (Cu) or nickel (Ni) and tin (Sn) is less likely to undergo deformation by heat even when soldering is performed when the multilayer ceramic capacitor 1 is mounted on a wiring substrate, and may reliably maintain the shape of the second region 42. In particular, for example, an intermetallic compound formed by adding tin (Sn) to an alloy of copper (Cu) and nickel (Ni) is preferable as a component of the second region 42.

The metal region MP formed by the metal powder includes, for example, a phenol resin. The phenol resin covers the particles of the intermetallic compound and is scattered so as to fill the gaps between the particles. The phenol resin may not completely cover the particles of the intermetallic compound. In addition, by using the phenol resin, it is possible to reduce the amount of the gas generated in the heat treatment for forming the second region 42, and thus it is possible to reduce the void P in the second region 42. The phenol resin may be provided on the surface of the second region 42 and cover at least a portion of the surface of the second region 42. By covering the surface of the second region 42 with the phenol resin, it is possible to improve the smoothness of the surface of the second region, and it is possible to improve the mechanical strength of the spacers 4.

Examples of the phenol resin include novolac-type phenol resins such as phenol novolac resins, phenol aralkyl resins, cresol novolac resins, tert-butylphenol novolac resins, or nonylphenol novolac resins, resol-type phenol resins, or polyoxystyrenes such as polyparaoxystyrene.

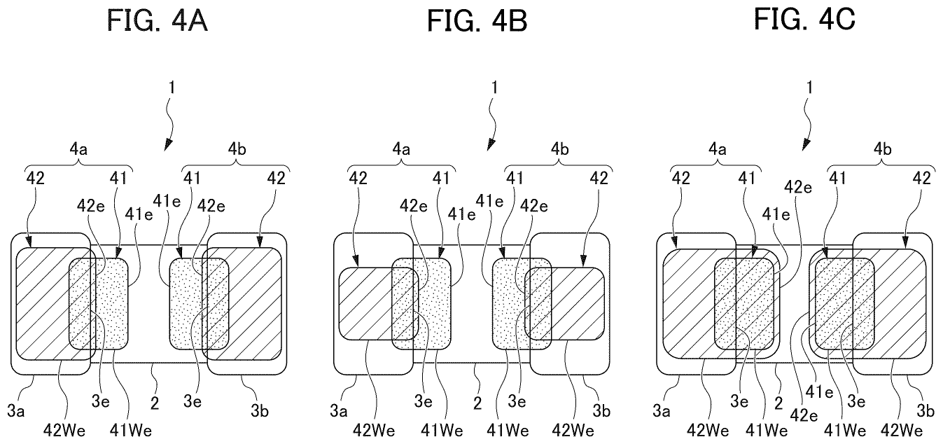

As shown in FIGS. 4A, 4B, and 4C, the metal powder MF may be included in the resin region RP including the phenol resin. The shrinkage of the phenol resin is reduced or prevented by the metal powder MF, such that it is possible to relax the shrinkage stress due to the phenol resin.

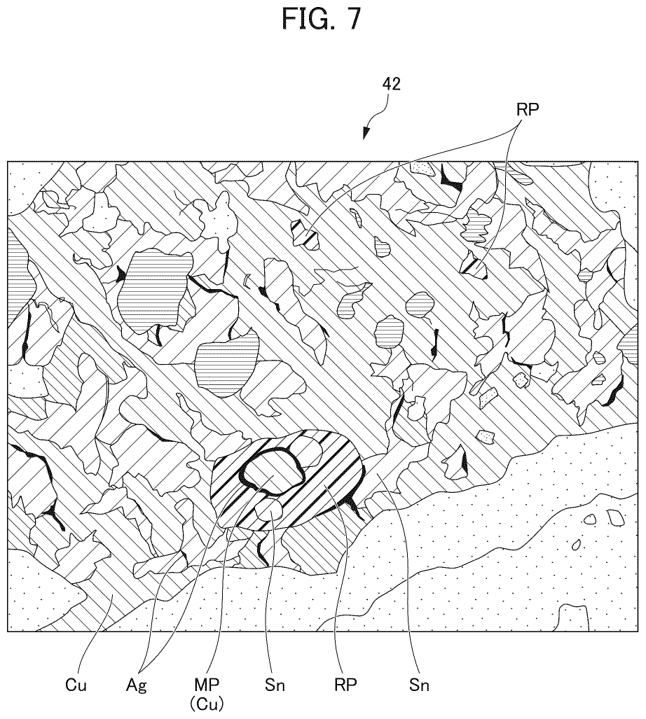

FIG. 7 shows an example of the configuration of the second region 42 when the second region is formed using epoxy resin. FIG. 7 is a partially enlarged view of a cross section of an internal region of the second region 42.

The second region 42 shown in FIG. 7 includes, for example, a tin (Sn) region, a resin region RP, a metal region MP including copper (Cu) or copper (Cu) and nickel (Ni), and a silver (Ag) region. Although shown as Cu in the drawings, the metal region MP includes, for example, either copper (Cu) or a metal including copper (Cu) and nickel (Ni). The metal region MP may include tin (Sn), for example. In addition, for example, the metal including copper (Cu) and nickel (Ni) may be alloyed with copper (Cu) and nickel (Ni), or may be an intermetallic compound including tin (Sn). Tin (Sn) may be included in the silver (Ag) region. These regions included within tin (Sn) may be detected by WDX or EDX analysis.

In addition, for example, the resin region RP includes inside the metal region MP including tin (Sn), copper (Cu) with its periphery covered by silver (Ag), or copper (Cu) and nickel (Ni). When the metal region MP includes copper (Cu) and nickel (Ni), for example, the copper (Cu) and nickel (Ni) may be alloyed, or may further include tin (Sn) to form an intermetallic compound. In particular, in the resin region RP, the composition conjugated as a material is detected as it is.

The different materials used for the first region 41 and the second region 42 are not limited to the case where the components included in the first region 41 and the second region 42 are entirely or partially different from each other, and include, for example, cases where the components are common but the contents are different from each other, cases where the compositions are different from each other, or the like.

The difference in component may be detected, for example, as follows. The multilayer ceramic capacitor is polished in parallel or substantially in parallel to the mounting surface of the multilayer ceramic capacitor and up to about one sixth of the transverse direction to expose a cross section of the height×longitudinal direction. In the cross section obtained by polishing the multilayer ceramic capacitor, for example, the cross section is enlarged to a total magnification of about 50 times with a microscope (BX-51) and photographed with a digital microscope (DP22 available from Olympus Corporation). In addition, example embodiments of the present invention are not limited to this, and a microscope (Axio (registered trademark)—Imager-MAT, available from ZEISS) may be used to perform photographing at a total magnification of 100 to 500 times.

FIGS. 4A, 4B, and 4C are plan views of the spacers 4 as viewed from the lamination direction T. FIGS. 4A, 4B, and 4C show three example embodiments of the present invention in which the shapes and sizes of the first regions 41 and the second regions 42 are mutually different.

As shown in FIGS. 4A, 4B, and 4C, the first regions 41 may each cover a portion of the multilayer body 2 and a portion of a corresponding one of the external electrodes 3. Since each of the first regions 41 covers a portion of the multilayer body 2 and an edge portion 3e of the corresponding one of the external electrodes 3 continuously, it is possible to relax stress concentrated at the edge portion 3e of the external electrode 3, and it is possible to improve the deflection strength. In addition, it is possible to reduce or prevent moisture infiltration from the edge portion 3e of the external electrode 3.

It is preferable that, by a corresponding one of the second regions 42 covering a portion of a corresponding one of the external electrodes 3 and a portion of a corresponding one of the first regions 41, at least a portion of a corresponding one of the first regions 41 is provided between the multilayer body 2 and the second region 42.

With such a configuration, it is possible to make the thickness in the lamination direction T of the first region 41 smaller than the thickness in the lamination direction T of the second region and to make the thickness in the lamination direction T of the first region 41 smaller than the thickness in the lamination direction T of the external electrode 3, and furthermore, by making the thickness in the lamination direction T of the first region 41 smaller, it is possible to configure the dimension in the direction perpendicular or substantially perpendicular to the mounting surface of the multilayer ceramic capacitor 1 relatively small, such that it is possible to increase the degrees of freedom in the configuration when mounting the multilayer ceramic capacitor 1.

The thickness in the lamination direction T of the first region 41 may be obtained, for example, by the following method. First, the multilayer ceramic capacitor 1 is polished to a position corresponding to about one-sixth the dimension in the width direction W to expose the LT cross-section parallel or substantially parallel to the length direction L and the lamination direction T. The LT cross-section is photographed at a total magnification of about 100 times to about 500 times using a microscope (Axio (registered trademark)—Imager-MAT, available from ZEISS). From the obtained image, the first region is divided into ten equal or substantially equal portions in the length direction L, the thickness in the lamination direction T is measured at the center of each of the ten regions, and the average value thereof may be used as the thickness in the lamination direction T of the first region 41.

As shown in FIGS. 4A and 4B, when viewing either one of the first spacer 4a or the second spacer 4b, it is possible to provide the spacer 4 such that an edge 41e of the first region 41 located adjacent to the middle of the multilayer body 2 in the length direction L is located closer to the middle of the multilayer body 2 than an edge 42e of the second region 42 located adjacent to the middle of the multilayer body 2 in the length direction L. In addition, as shown in FIG. 4B, the spacer 4 may be provided such that an edge 41We of the first region 41 is located outside an edge 42We of the second region 42 in the width direction W.

By providing the spacer 4 in such a configuration, it is possible to sufficiently secure the area where the first region 41 is bonded to the multilayer body 2 and the area where the second region 42 is bonded to the first region 41, and it is possible to improve the bonding strength between the capacitor main body 1A and the spacer 4.

An orientation determining mark may be provided in a portion of one of the spacers 4 or a portion of the capacitor main body 1A. The orientation determining mark is provided in order to indicate the orientation for the surface on which the spacer 4 is provided to face the wiring substrate when the multilayer ceramic capacitor is mounted on the wiring substrate. In order to provide the orientation determining mark, for example, it is possible to provide the first region 41 or the second region 42 of the spacer 4 with a color different from that of the external electrode 3, provide a printing mark for determining the orientation such as a QR code (registered trademark), provide a recessed portion in a portion of the multilayer body 2, or the like.

In a case where the first region 41 is made of an insulating material, the first region 41 may completely cover the second main surface of the multilayer body 2 facing the mounting surface, or may continuously cover a portion between the first external electrode 3a and the second external electrode 3b on opposite sides in the length direction L.

The thickness in the lamination direction T of the spacer 4 is preferably, for example, about 50 μm or more and about 250 μm or less. The thickness in the lamination direction T of the spacer 4 may be appropriately designed according to the size of the multilayer ceramic capacitor 1 and, for example, when the dimension in the length direction L of the capacitor main body 1A is about 1.6 mm, the dimension in the width direction W is about 0.8 mm, and the dimension in the lamination direction T is about 0.8 mm, the thickness in the lamination direction T of the spacer 4 is preferably about 160 μm.

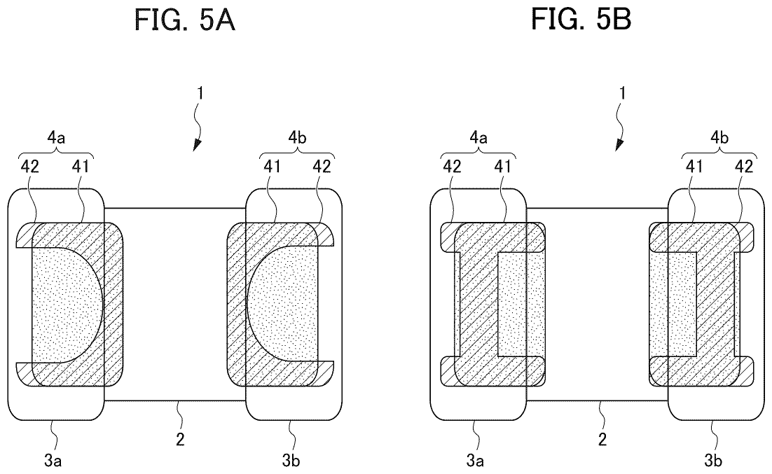

FIGS. 5A and 5B show two example embodiments of the present invention in which the shapes of the second regions 42 of the spacer 4 are different. In the example embodiment shown in FIG. 5A, recessed portions are provided on the left lateral surface of the first spacer 4a and the right lateral surface of the second spacer 4b to define U-shapes, respectively, and in the example embodiment shown in FIG. 5B, recessed portions are provided on the left and right lateral surfaces of the first spacer 4a and the left and right lateral surfaces of the second spacer 4b to define H-shapes, respectively.

As described above, by providing the recessed portions on the lateral surfaces of the spacers 4, it is possible to accommodate the melted excess solder in the recessed portion, while ensuring a sufficient contact area with the wiring substrate required at the time of mounting, and it is possible to prevent the solder from being spread high in the direction perpendicular or substantially perpendicular to the mounting surface of the capacitor main body 1A, such that the occurrence of acoustic noise can be reduced or prevented more reliably.

### Manufacturing Method of Multilayer Ceramic Capacitor 1

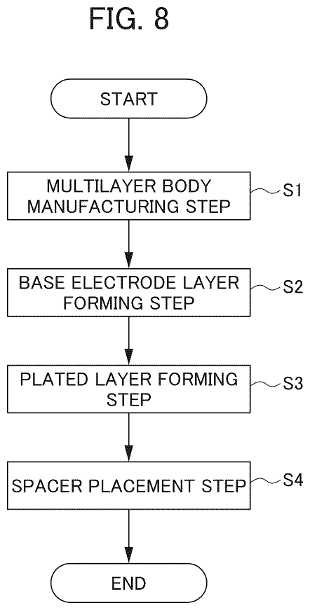

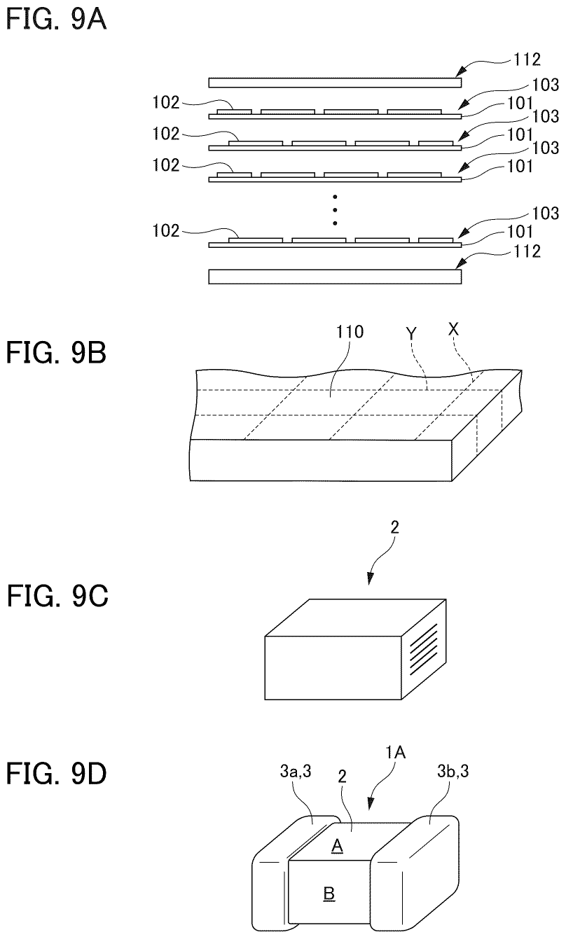

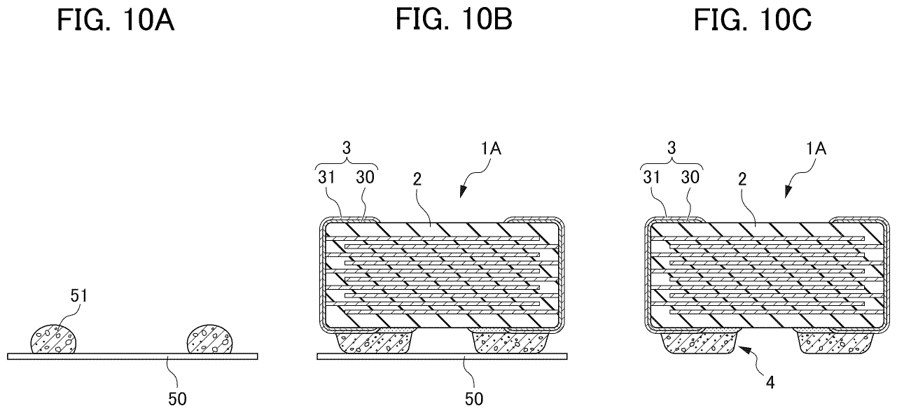

FIG. 8 is a flowchart showing an example of a method of manufacturing the multilayer ceramic capacitor 1 according to an example embodiment of the present invention. The example of a method for manufacturing the multilayer ceramic capacitor 1 includes a multilayer body manufacturing step S1, a base electrode layer forming step S2, a plated layer forming step S3, and a spacer placement step S4. FIGS. 9A to 9D are diagrams showing the multilayer body manufacturing step S1, the base electrode layer forming step S2, and the plated layer forming step S3, respectively. FIGS. 10A to 10C are diagrams showing a step of forming the second region in the spacer placement step S4.

### Multilayer Body Manufacturing Step S1

The ceramic slurry including the ceramic powder, the binder, and the solvent is molded into a sheet shape on the surface of the carrier film by using, for example, a die coater, a gravure coater, a microgravure coater, or the like to produce ceramic green sheets for lamination 101 defining and functioning as the dielectric layer 14. Next, an electrically conductive paste is printed on the ceramic green sheets 101 in a band shape by, for example, screen printing, inkjet printing, gravure printing, or the like, and a conductive pattern 102 defining and functioning as the internal electrode layer 15 is printed on the surface of each of the ceramic green sheets 101 to produce a material sheet 103.

Subsequently, as shown in FIG. 9A, a plurality of material sheets 103 are stacked so that the conductive patterns 102 face the same direction and the conductive patterns 102 are shifted by, for example, about a half pitch in the length direction between the adjacent material sheets 103. Further, outer layer portion ceramic green sheets 112 defining and functioning as the outer layer portion 12 are stacked on both sides of the plurality of laminated material sheets 103, respectively.

The plurality of stacked material sheets 103 and the ceramic green sheets 112 for manufacturing the outer layer portion are pressure-bonded by, for example, a hydrostatic press or the like to form a mother block 110 shown in FIG. 9B.

Next, the mother block 110 is cut along the cutting line X and the cutting line Y intersecting the cutting line X shown in FIG. 9B, and fired to manufacture a plurality of multilayer bodies 2 shown in FIG. 9C.

### Base Electrode Layer Forming Step S2

Subsequently, the base electrode layer 30 is formed by applying and firing an electrically conductive paste including, for example, copper (Cu) to the end surface C of the multilayer body 2. The base electrode layer 30 is not only provided on the end surface C on each of both sides of the multilayer body 2, but also extends to the main surfaces A and the lateral surfaces B of the multilayer body 2 so as to cover a portion of each of the main surfaces A adjacent to the respective end surfaces C. However, the present invention is not limited to this, and other metals and other components may be included, and two base electrode layers may be provided.

### Plated Layer Forming Step S3

Next, a plated layer 31 is formed on the surface of each of the base electrode layers 30 to manufacture the capacitor main body 1A shown in FIG. 9D. The plated layer 31 may include, for example, a nickel (Ni) plated layer and a tin (Sn) plated layer provided on a surface of the nickel (Ni) plated layer, but is not limited thereto.

### Spacer Placement Step S4

The spacer placement step S4 includes a first region forming step and a second region forming step described below.

### First Region Forming Step

A paste for the first region defining and functioning as the material of the first region is applied by, for example, a printing method such as a dispensing method or a squeegee method, a sputtering method, or the like so as to cover a portion of the multilayer body and a portion of the external electrode. At this time, it is possible to provide the first region in any area by, for example, changing the design of the mask, such as whether or not a portion of the external electrode is covered. It is possible to adjust the thickness in the lamination direction T of the first region 41 by adjusting the amount of the paste for the first region.

Thereafter, the paste for the first region is heated and cured at an arbitrary temperature. For example, when the paste for the first region includes a metal component, it is possible to form the first region by firing, and when the paste for the first region includes a resin component, it is possible to form the first region by thermal curing.

### Second Region Forming Step

Pastes for the second regions 51 used to form the second regions 42 are prepared. Examples of the pastes for the second regions 51 include the following phenol resin paste and epoxy resin paste.

### Phenol Resin System

The pastes for the second regions 51 each include, for example, a metal including copper (Cu), nickel (Ni), tin (Sn), or silver (Ag), a phenol resin, a solvent, and an additive.

Examples of the phenol resin include novolac-type phenol resins such as phenol novolac resins, phenol aralkyl resins, cresol novolac resins, tert-butylphenol novolac resins, nonylphenol novolac resins, resol-type phenol resins, or polyoxystyrenes such as polyparaoxystyrene.

Each of the second regions 42 is formed using, for example, a holding substrate 50 as shown in FIGS. 10A to 10C. Each of the pastes for the second regions 51 is provided on the holding substrate 50 by, for example, a screen printing method, a dispensing method, or the like.

Next, as shown in FIG. 10B, the capacitor main body 1A is mounted on the upper surface of the holding substrate 50 in a posture in which the second main surface A2 faces the holding substrate 50. At this time, the external electrodes 3 of the capacitor main body 1A and the paste for the second region 51 are aligned with each other, and the paste for the second region 51 adheres to the capacitor main body 1A.

In this state, a heating step is performed. When at least a portion of the metal in the paste generates an intermetallic compound to form the metal region MP, a portion of the phenol resin is taken into the metal region MP and cured while being partially discharged from the metal region MP to form the spacers 4 bonded to the capacitor main body 1A.

Thereafter, the capacitor main body 1A is separated from the holding substrate 50 together with the spacers 4, and the state shown in FIG. 10C is obtained. In addition, the present invention is not limited to such a manufacturing method, and, for example, the second regions 42 may be formed by directly providing the paste for the second region in a desired shape on the surface of the capacitor main body 1A and performing heat treatment.

### Epoxy Resin System

The paste for the second region 51 includes, for example, the metal including tin (Sn), copper (Cu) covered by silver (Ag), or copper (Cu) and nickel (Ni) covered by silver (Ag) instead of copper (Cu), a resin made of an epoxy resin, and a solvent.

The epoxy resin is, for example, a bisphenol A type epoxy resin. The solvent is, for example, diethylene glycol monobutyl ether, diethylene glycol monoethyl ether or diethylene glycol monomethyl ether. In addition, a bump-forming paste 44 does not include a curing agent such as phenol resin or imidazole, for example.

The volume ratio of tin (Sn) to the total volume of the metal is, for example, about 70% or more and about 90% or less. The volume ratio of the metal to the resin is, for example, about 70% or more and about 90% or less.

The step of forming the second region may use the step shown in FIGS. 10A to 10C described above.

Although it is possible to perform the heat treatment for forming the first region or the second region in each of the first region forming step and the second region forming step as described above, the heat treatment may be performed at the same time depending on the components of the paste for the first region and the paste for the second region.

Although example embodiments of the present invention have been described above, the present invention is not limited to the example embodiments, and may be implemented in various modes without departing from the gist of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including two main surfaces on opposite sides in a lamination direction, two end surfaces on opposite sides in a length direction intersecting the lamination direction, and two lateral surfaces on opposite sides in a width direction intersecting the lamination direction and the length direction;
two external electrodes each covering the corresponding one of the two end surfaces and a portion of each of the two main surfaces on opposite sides that is continuous from the corresponding one of the two end surfaces; and
two spacers on one of the two main surfaces of the multilayer body; wherein
each of the two spacers includes a first region covering a portion of the multilayer body and a second region covering a portion of a corresponding one of the two external electrodes; and
the first region and the second region include different materials.

2. The multilayer ceramic electronic component according to claim 1, wherein the first region covers the portion of the multilayer body and a portion of a corresponding one of the external electrodes.

3. The multilayer ceramic electronic component according to claim 1, wherein the second region covers the portion of the corresponding one of the external electrodes and a portion of the first region.

4. The multilayer ceramic electronic component according to claim 1, wherein an edge of the first region of a corresponding one of the two spacers located adjacent to a middle of the multilayer body in the length direction is located closer to the middle of the multilayer body than an edge of the second region of the corresponding one of the two spacers located adjacent to the middle of the multilayer body in the length direction.

5. The multilayer ceramic electronic component according to claim 1, wherein an edge of the first region is located outside an edge of the second region in the width direction.

6. The multilayer ceramic electronic component according to claim 1, wherein the first region of each of the two spacers includes an insulating resin.

7. The multilayer ceramic electronic component according to claim 1, wherein the first region of each of the two spacers includes an electrically conductive component and a ceramic material.

8. The multilayer ceramic electronic component according to claim 1, wherein the first region of each of the two spacers includes metal film.

9. The multilayer ceramic electronic component according to claim 2, wherein the second region covers the portion of the corresponding one of the external electrodes and a portion of the first region.

10. The multilayer ceramic electronic component according to claim 2, wherein an edge of the first region of a corresponding one of the two spacers located adjacent to a middle of the multilayer body in the length direction is located closer to the middle of the multilayer body than an edge of the second region of the corresponding one of the two spacers located adjacent to the middle of the multilayer body in the length direction.

11. The multilayer ceramic electronic component according to claim 2, wherein an edge of the first region is located outside an edge of the second region in the width direction.

12. The multilayer ceramic electronic component according to claim 3, wherein an edge of the first region of a corresponding one of the two spacers located adjacent to a middle of the multilayer body in the length direction is located closer to the middle of the multilayer body than an edge of the second region of the corresponding one of the two spacers located adjacent to the middle of the multilayer body in the length direction.

13. The multilayer ceramic electronic component according to claim 3, wherein an edge of the first region is located outside an edge of the second region in the width direction.

14. The multilayer ceramic electronic component according to claim 4, wherein an edge of the first region is located outside an edge of the second region in the width direction.

15. The multilayer ceramic electronic component according to claim 9, wherein an edge of the first region of a corresponding one of the two spacers located adjacent to a middle of the multilayer body in the length direction is located closer to the middle of the multilayer body than an edge of the second region of the corresponding one of the two spacers located adjacent to the middle of the multilayer body in the length direction.

16. The multilayer ceramic electronic component according to claim 9, wherein an edge of the first region is located outside an edge of the second region in the width direction.

17. The multilayer ceramic electronic component according to claim 12, wherein an edge of the first region is located outside an edge of the second region in the width direction.

18. The multilayer ceramic electronic component according to claim 15, wherein an edge of the first region is located outside an edge of the second region in the width direction.

19. The multilayer ceramic electronic component according to claim 10, wherein an edge of the first region is located outside an edge of the second region in the width direction.
